(19) United States
(12) Patent Application Publication
(10) Pub. No.: US 2026/0090520 A1
(43) Pub. Date: Apr. 2, 2026

(54) Illuminated Leash Device

(71) Applicant: Rusty Tilton, Emporia, KS (US)

(72) Inventor: Rusty Tilton, Emporia, KS (US)

(21) Appl. No.: 18/904,742

(22) Filed: Oct. 2, 2024

(51) Int. Cl. A01K 27/00

(52) U.S. Cl. CPC A01K 27/004; A01K 27/006

(57) ABSTRACT

An illuminated leash device for projecting light from the leash to improve safety during nighttime walks include a housing having an interior space. A slot extends through the housing into the interior space. A spool is rotatably positioned in the interior space. A strap is coiled around the spool and extends through the slot. The spool is rotatable for extension and retraction of the strap. A plurality of lights are coupled to the strap. The plurality of lights are illuminatable wherein the plurality of lights are visible on the strap while the plurality of lights are illuminated. A power source is electrically coupled to the plurality of lights wherein the power source is activatable to illuminate the plurality of lights. A switch is electrically coupled the power source wherein the switch is actuatable to selectively activate and deactivate the power source.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to leashes and more particularly pertains to a new leash for projecting light from the leash to improve safety during nighttime walks.

### (2) Description of Related Art Including Information Disclosed Under 37 CFR 1.97 and 1.98.

The prior art relates to leashes. Leashes are commonly used for walking pets, such as dogs. There are a wide variety of leashes, in many different colors, lengths, and styles. For example, some leashes are extendable and retractable, allowing the length of the leash to adjust and providing the pet with increased independence while still allowing the user to retain control over the pet. Other leashes are designed with materials that reflect light, so that the leashes can be reflected from the light of passing vehicles and other objects when the user is walking the pet in the dark. However, the prior art lacks disclosure of a retractable leash that has its own lights, for illuminating the dog leash even when there are no lights from vehicles or other objects to reflect off of the leash materials. Such a retractable, illuminated leash would be particularly useful for individuals who are walking their pets in the dark, for example in rural areas.

### BRIEF SUMMARY OF THE INVENTION

An embodiment of the disclosure meets the needs presented above by generally comprising a housing having an interior space. A slot extends through the housing into the interior space. A spool is rotatably positioned in the interior space. A strap is coiled around the spool. The spool is rotatable in a first direction to uncoil the strap from the spool for extension of the strap from the housing. The spool is rotatable in a second direction to coil the strap around the spool for retraction of the strap into the housing. The strap extends through the slot. A plurality of lights are coupled to the strap. The plurality of lights are illuminatable wherein the plurality of lights are visible on the strap while the plurality of lights are illuminated. A power source is electrically coupled to the plurality of lights wherein the power source is activatable to illuminate the plurality of lights. A switch is electrically coupled the power source wherein the switch is actuatable to selectively activate and deactivate the power source.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front isometric view of an illuminated leash device according to an embodiment of the disclosure.

FIG. 2 is a side view of an embodiment of the disclosure.

FIG. 3 is a side view of an embodiment of the disclosure.

FIG. 4 is an end view of an embodiment of the disclosure.

FIG. 5 is a bottom view of an embodiment of the disclosure.

FIG. 6 is a cross-sectional view of an embodiment of the disclosure.

FIG. 7 is a detail view of an embodiment of the disclosure.

FIG. 8 is a detail view of an embodiment of the disclosure.

FIG. 9 is a side view of an embodiment of the disclosure.

FIG. 10 is an in-use view of an embodiment of the disclosure.

### DETAILED DESCRIPTION OF THE INVENTION

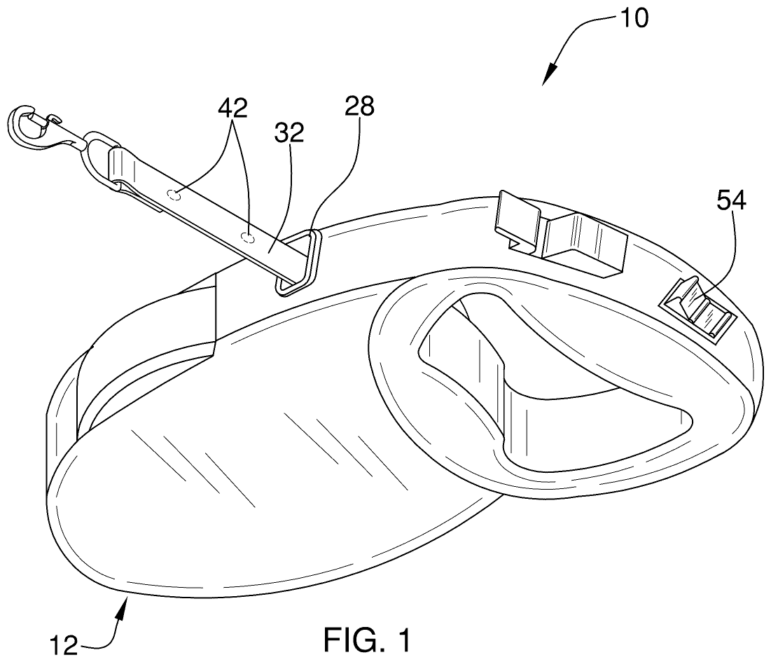

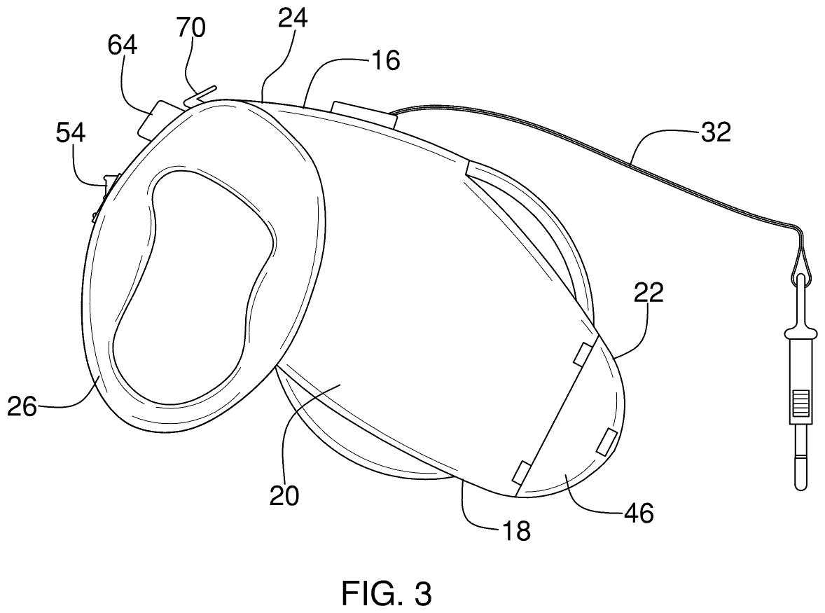

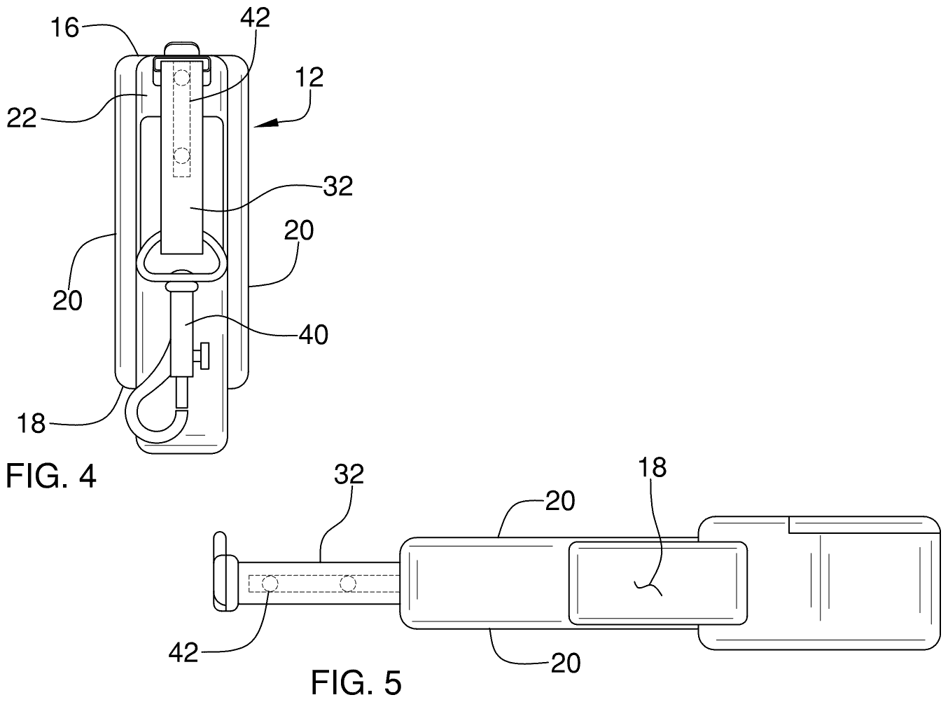

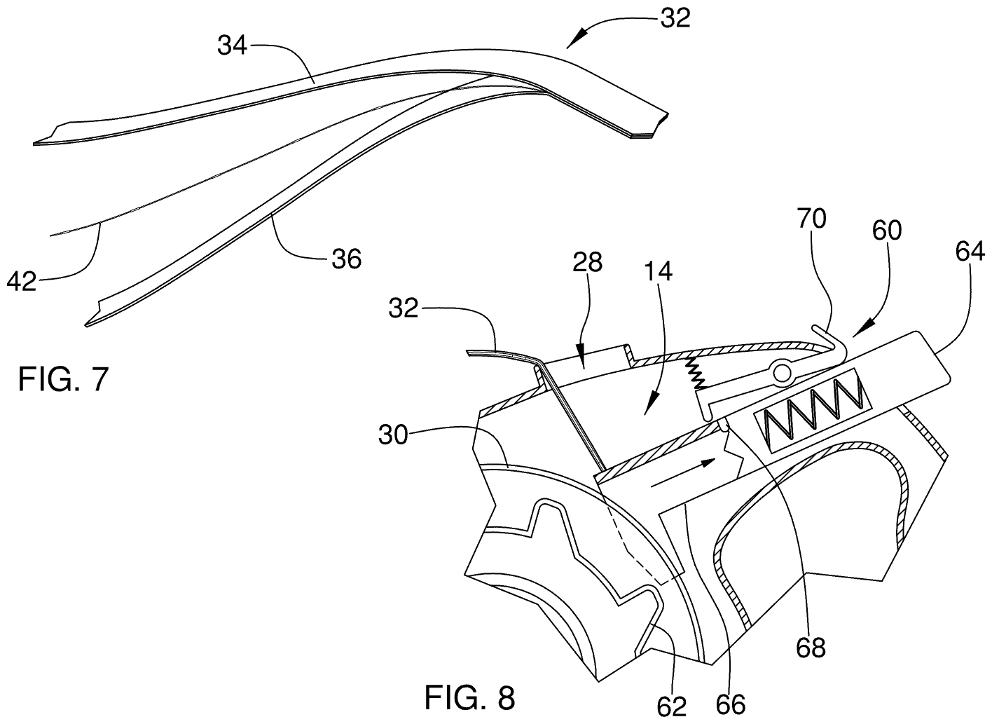

With reference now to the drawings, and in particular to FIGS. 1 through 10 thereof, a new leash embodying the principles and concepts of an embodiment of the disclosure and generally designated by the reference numeral 10 will be described.

As best illustrated in FIGS. 1 through 10, the illuminated leash device 10 generally comprises a housing 12 that has an interior space 14. For example, the housing 12 may have a top side 16, a bottom side 18, and a peripheral side 20 that is coupled to and extends between the top side 16 and the bottom side 18 to define the interior space 14. The peripheral side 20 may have a forward end 22 and a handle end 24.

A handle 26 may be coupled to the handle end 24 of the peripheral side 20 of the housing 12. In some embodiments, the handle 26 is integrally coupled to the housing 12. A slot 28 extends through the housing 12 into the interior space 14. For example, the slot 28 may be positioned on the top side 16 and may be proximate to the handle end 24.

A spool 30 is rotatably positioned in the interior space 14. The spool 30 may be coupled to the housing 12. The spool 30 may comprise an electrically conductive material wherein the electrically conductive material is configured to facilitate transfer of an electrical current through the spool 30. The electrically conductive material may include, for example, copper, aluminum, steel, silver, or another material that has low resistance to electrical currents and that has an atomic structure allowing electrons to move easily between atoms.

A strap 32 is coiled around the spool 30. The spool 30 is generally rotatable in a first direction to uncoil the strap 32 from the spool 30 for extension of the strap 32 from the housing 12. The spool 30 is also generally rotatable in a second direction to coil the strap 32 around the spool 30 for retraction of the strap 32 into the housing 12. The strap 32 extends and retracts through the slot 28.

In some embodiments, the strap 32 may include a strap first layer 34. In some embodiments, the strap first layer 34 may be translucent. A strap second layer 36 may be coupled to the strap first layer 34. The strap second layer 36 is generally coextensive with the strap first layer 34. In certain embodiments, the strap second layer 36 may be translucent. A strap terminal end 38 may be distally positioned relative to the spool 30. A clip 40 may be coupled to the strap terminal end 38. The clip 40 generally has a size exceeding a size of the slot 28 wherein the clip 40 inhibits the strap terminal end 38 from being retracted into the housing 12.

A plurality of lights 42 are coupled to the strap 32. The plurality of lights 42 are illuminatable wherein the plurality of lights 42 are visible on the strap 32 while the plurality of lights 42 are illuminated. For example, the plurality of lights 42 may be positioned between the strap first layer 34 and the strap second layer 36 wherein the plurality of lights 42 shine through the strap first layer 34 and the strap second layer 36 while the plurality of lights 42 are illuminated. The plurality of lights 42 may be electrically coupled to the electrically conductive material of the spool 30 wherein the electrically conductive material of the spool 30 is configured to facilitate transfer of the electrical current from the spool 30 through the plurality of lights 42. Each light of the plurality of lights 42 may comprise a light emitting diode.

A power source 44 is positioned in the interior space 14 of the housing 12. The power source 44 is electrically coupled to the plurality of lights 42 wherein the power source 44 is activatable to illuminate the plurality of lights 42. For example, the power source 44 may be a battery. The battery may be rechargeable. For example, the battery may comprise two rechargeable AA batteries, although other types of rechargeable batteries are also contemplated. In alternative examples, the power source 44 may comprise two disposable AA batteries, although other types of disposable batteries are also contemplated.

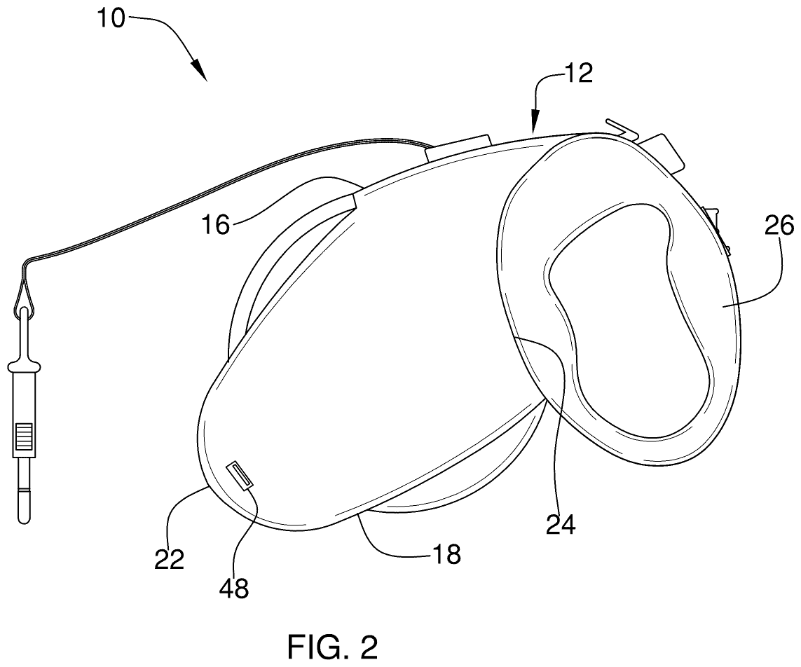

An access door 46 may be removably coupled to the housing 12. In other embodiments, the access door 46 may be pivotably coupled to the housing 12. The access door 46 is generally openable to expose the power source 44 wherein the access door 46 is configured to facilitate recharging the battery. The access door 46 may be positioned proximate to the forward end 22 of the housing 12. Alternatively, a charging port 48 may be electrically coupled to the power source 44. The charging port 48 may be inset into the peripheral side 20 of the housing 12. The charging port 48 may be exposed within the peripheral side 20 of the housing 12. For example, as shown in FIG. 2, the charging port 48 may be configured to receive a charging cable for recharging the power source 44.

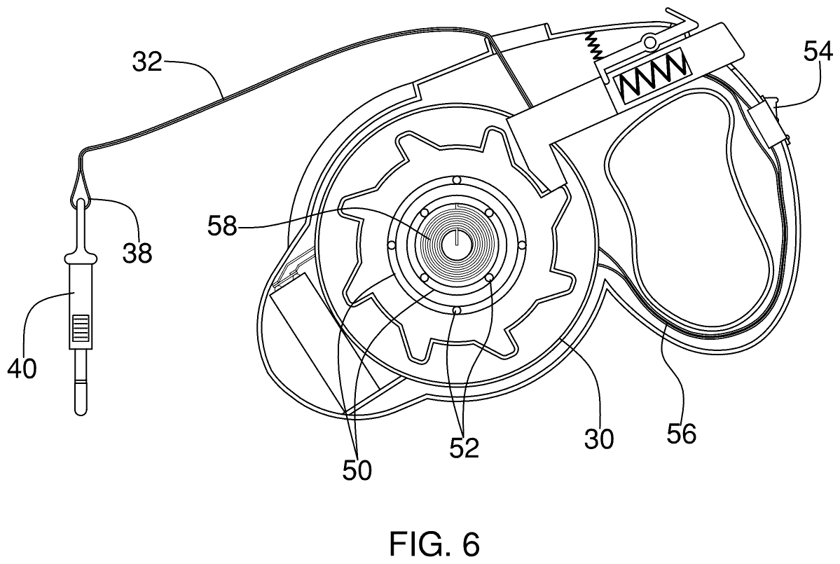

A pair of grooves 50 may extend into the spool 30. Each groove of the pair of grooves 50 may be circular. The pair of grooves 50 are generally spaced from each other. More specifically, the pair of grooves 50 may each be positioned on a single surface of the spool 30, for example wherein the pair of grooves 50 are concentric with one another as shown in FIG. 6. Alternatively, the pair of grooves 50 may each be positioned on a respective surface of the spool 30.

A plurality of members 52 may be positioned within each groove of the pair of grooves 50. The plurality of members 52 are generally electrically conductive wherein the plurality of members 52 are configured to facilitate transfer of the electrical current through the spool 30 between the power source 44 and the plurality of lights 42. For example, each member of the plurality of members 52 may be a ball bearing. In some embodiments, the plurality of members 52 includes a single member that is positioned within each groove, for a total of two members. In other embodiments, the plurality of members 52 includes two or more members that are positioned within each groove, for a total of four or more members. The plurality of members 52 may be movably positioned within the pair of grooves 50, for example wherein the plurality of members 52 are able to slide or roll within each respective groove of the pair of grooves 52. Alternatively, the plurality of members 52 may be statically positioned within the pair of grooves 52, as long as the electrical current can travel through the plurality of members 52 between the power source 44 and the plurality of lights 42.

A switch 54 is electrically coupled to the power source 44. The switch 54 is actuatable to selectively activate and deactivate the power source 44. The switch 54 is generally configured to inhibit transfer of the electrical current from the power source 44 through the spool 30 to the plurality of lights 42 while the power source 44 is deactivated. The switch 54 may be positioned on the handle 26 wherein the switch 54 is configured to facilitate a user 72 in selectively activating and deactivating the power source 44.

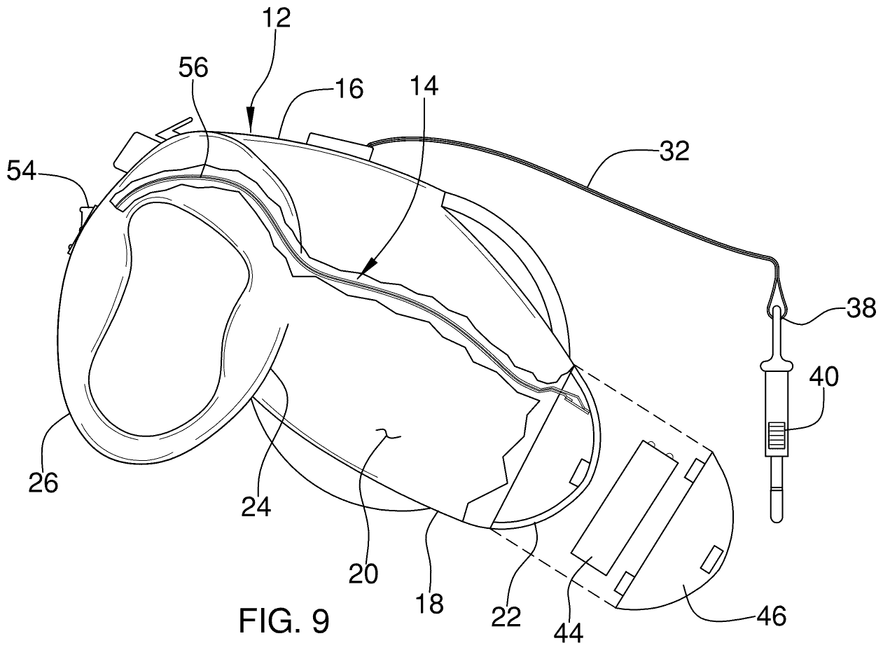

For example, an electrical wire 56 may extend from the power source 44 to the switch 54, as shown in FIG. 9. The electrical wire 56 may also extend from the switch 54 to the spool 30, as shown in FIG. 6. When the switch 54 is actuated to activate the power source 44, the electrical current may travel through the electrical wire 56 from the power source 44 to the switch 54 and continue on to the spool 30. The electrical current may travel through the spool 30, for example through the electrically conductive material of the spool 30, or through the plurality of members 52 positioned within the pair of grooves 50, to the plurality of lights 42. When the switch 54 is actuated to deactivate the power source 44, the electrical current may be inhibited from flowing from the switch 54 through the spool 30 to the plurality of lights 42. By using the electrically conductive material for the spool 30, the plurality of members 52, or both, the plurality of lights 42 do not need to be directly connected to the electrical wire 56, such that the plurality of lights 42 are free to extend and retract with the strap 32.

A spring 58 may be coupled to the spool 30. The spring 58 generally has a spring tension. The spring tension may increase as the spool 30 is rotated in the first direction for extension of the strap 32 from the housing 12. The spring tension may be released when the spool 30 is rotated in the second direction for retraction of the strap 32 into the housing 12 wherein the spring 58 is configured to retract the strap 32 into the housing 12.

A lock 60 may be coupled to the spool 30. The lock 60 may be releasably engageable with the spool 30 wherein the lock 60 selectively inhibits the spool 30 from being rotated in the first direction for extension of the strap 32 from the housing 12.

For example, a ratchet 62 may be positioned within the interior space 14 of the housing 12. The ratchet 62 is generally coupled to the spool 30. For example, the ratchet 62 may rotate in the first direction when the spool 30 rotates in the first direction. The ratchet 62 may also rotate in the second direction when the spool 30 rotates in the second direction.

A button 64 may be coupled to the housing 12, or the handle 26. The button 64 is actuatable to pivot inwardly toward the interior space 14 of the housing 12 and outwardly from the interior space 14 of the housing 12. A pawl 66 may be coupled to the button 64. The pawl 66 may be pivotably positioned within the interior space 14 of the housing 12. For example, the pawl 66 may be pivotable to contact the ratchet 62 when the button 64 is pivoted inwardly and the pawl 66 may be pivotable to release the ratchet 62 when the button 64 is pivoted outwardly. The pawl 66 generally inhibits the ratchet 62 from being rotated in the first direction while the pawl 66 is in contact with the ratchet 62.

A notch 68 may extend into the button 64. A lever 70 may be pivotably coupled to the housing 12, or the handle 26. The lever 70 may be pivotable downwardly to engage the notch 68. The lever 70 generally inhibits the button 64 from being pivoted inwardly or outwardly relative to the housing 12 while the lever 70 is engaged with the notch 68. The lever 70 may be pivotable upwardly to release the notch 68.

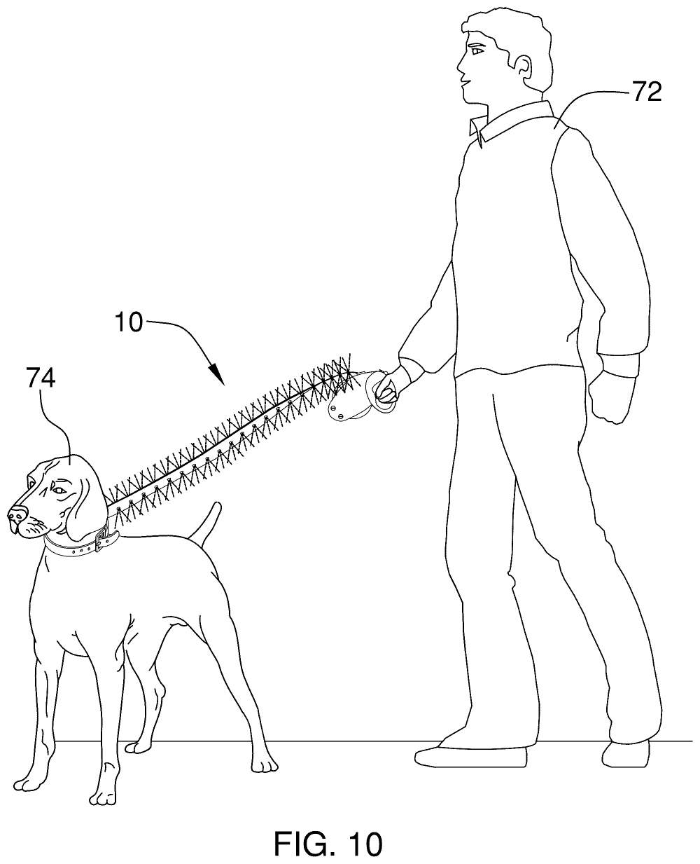

In use, the clip 40 may be releasably coupled to a leash or harness on a pet, for example when a user 72 wants to take the pet for a walk. The user 72 may actuate the switch 54 to illuminate the plurality of lights 42, as shown in FIG. 10. The plurality of lights 42 will provide a light source for the user 72 and the pet and will also make the user 72 and the pet more visible to other passers-by, such as vehicles. This light source will increase the safety of the pet and the user 72, particularly when the user 72 is walking the pet in low-lighting or dark conditions.

To inhibit the strap 32 from being fully extended relative to the housing 12, the lock 60 can be engaged. Specifically, the user 72 can push the button 64 so that the pawl 66 will slide, or pivot, into contact with the ratchet 62 coupled to the spool 30. Then, the user 72 can pivot the lever 70 downwardly into the notch 68 to retain the position of the button 64, holding the pawl 66 in contact with the ratchet 62. To release the strap 32, the user 72 can simply pivot the lever 70 upwardly to release the lever 70 from the notch 68, allowing the pawl 66 to be released from the ratchet 62.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A leash assembly comprising:
a housing having an interior space;
a slot extending through the housing into the interior space;
a spool being rotatably positioned in the interior space;
a strap being coiled around the spool, the spool being rotatable in a first direction to uncoil the strap from the spool for extension of the strap from the housing, the spool being rotatable in a second direction to coil the strap around the spool for retraction of the strap into the housing, the strap extending through the slot, the strap including a strap first layer and a strap second layer being coupled to the strap first layer, each of the strap first layer and the strap second layer being flexible and planar;
a plurality of lights being coupled to the strap, the plurality of lights being illuminatable wherein the plurality of lights are visible on the strap while the plurality of lights are illuminated, the plurality of lights being positioned between the strap first layer and the strap second layer;
a power source being electrically coupled to the plurality of lights wherein the power source is activatable to illuminate the plurality of lights; and
a switch being electrically coupled the power source wherein the switch is actuatable to selectively activate and deactivate the power source.

2. The leash assembly of claim 1, further comprising a handle being coupled to the housing.

3. The leash assembly of claim 2, wherein the handle is integrally coupled to the housing.

4. The leash assembly of claim 1, wherein the spool comprises an electrically conductive material wherein the electrically conductive material is configured to facilitate transfer of an electrical current through the spool.

5. The leash assembly of claim 4, wherein the plurality of lights is electrically coupled to the electrically conductive material of the spool wherein the electrically conductive material of the spool is configured to facilitate transfer of the electrical current from the spool through the plurality of lights.

6. (canceled)

7. The leash assembly of claim 1, wherein the strap first layer is translucent and wherein the strap second layer is translucent.

8. The leash assembly of claim 1, further comprising:
a pair of grooves extending into the spool; and
a member being positioned within each groove of the pair of grooves, the member being electrically conductive wherein the member is configured to facilitate transfer of an electrical current through the spool between the power source and the plurality of lights.

9. The leash assembly of claim 1, further comprising a spring being coupled to the spool, the spring having a spring tension, the spring tension increasing as the spool is rotated in the first direction for extension of the strap from the housing, the spring tension being released when the spool is rotated in the second direction for retraction of the strap into the housing wherein the spring is configured to retract the strap into the housing.

10. The leash assembly of claim 1, further comprising a lock being coupled to the spool, the lock being releasably engageable with the spool wherein the lock selectively inhibits the spool from being rotated in the first direction for extension of the strap from the housing.

11. The leash assembly of claim 10, the lock further comprising:
a ratchet being positioned within the interior space of the housing, the ratchet being coupled to the spool wherein the ratchet rotates in the first direction when the spool rotates in the first direction and wherein the ratchet rotates in the second direction when the spool rotates in the second direction;
a button being coupled to the housing, the button being actuatable to pivot inwardly toward the interior space of the housing and outwardly from the interior space of the housing; and
a pawl being coupled to the button, the pawl being pivotably positioned within the interior space of the housing wherein the pawl is pivotable to contact the ratchet when the button is pivoted inwardly and wherein the pawl is pivotable to release the ratchet when the button is pivoted outwardly, the pawl inhibiting the ratchet from being rotated in the first direction while the pawl is in contact with the ratchet.

12. The leash assembly of claim 11, the lock further comprising:
a notch extending into the button; and
a lever being pivotably coupled to the housing, the lever being pivotable downwardly to engage the notch wherein the lever inhibits the button from being pivoted inwardly or outwardly relative to the housing while the lever is engaged with the notch, the lever being pivotable upwardly to release the notch.

13. A leash assembly comprising:
a housing having an interior space, the housing having a top side, a bottom side, and a peripheral side being coupled to and extending between the top side and the bottom side to define the interior space, the peripheral side having a forward end and a handle end;
a handle being coupled to the handle end of the peripheral side of the housing, the handle being integrally coupled to the housing;
a slot extending through the top side of the housing into the interior space, the slot being positioned proximate to the handle end;
a spool being rotatably positioned in the interior space, the spool being coupled to the housing, the spool comprising an electrically conductive material wherein the electrically conductive material is configured to facilitate transfer of an electrical current through the spool;
a strap being coiled around the spool, the spool being rotatable in a first direction to uncoil the strap from the spool for extension of the strap from the housing, the spool being rotatable in a second direction to coil the strap around the spool for retraction of the strap into the housing, the strap extending through the slot, the strap including:
a strap first layer, the strap first layer being translucent and planar;
a strap second layer being coupled to the strap first layer, the strap second layer being coextensive with the strap first layer, the strap second layer being translucent and planar;
a strap terminal end being distally positioned relative to the spool;
a clip being coupled to the strap terminal end, the clip having a size exceeding a size of the slot wherein the clip inhibits the strap terminal end from being retracted into the housing;
a plurality of lights being coupled to the strap, the plurality of lights being illuminatable wherein the plurality of lights are visible on the strap while the plurality of lights are illuminated, the plurality of lights being positioned between the strap first layer and the strap second layer wherein the plurality of lights shine through the strap first layer and the strap second layer while the plurality of lights are illuminated, the plurality of lights being electrically coupled to the electrically conductive material of the spool wherein the electrically conductive material of the spool is configured to facilitate transfer of the electrical current from the spool through the plurality of lights, each light of the plurality of lights comprising a light emitting diode;
a power source being positioned in the interior space of the housing, the power source being electrically coupled to the plurality of lights wherein the power source is activatable to illuminate the plurality of lights, the power source being a battery, the battery being rechargeable;
a pair of grooves extending into the spool, each groove of the pair of grooves being circular, the pair of grooves being spaced from each other;
a plurality of members being positioned within each groove of the pair of grooves, the plurality of members being electrically conductive wherein the plurality of members are configured to facilitate transfer of the electrical current through the spool between the power source and the plurality of lights;
a switch being electrically coupled to the power source wherein the switch is actuatable to selectively activate and deactivate the power source, the switch being configured to inhibit transfer of the electrical current from the power source through the spool to the plurality of lights while the power source is deactivated, the switch being positioned on the handle wherein the switch is configured to facilitate a user in selectively activating and deactivating the power source;
a spring being coupled to the spool, the spring having a spring tension, the spring tension increasing as the spool is rotated in the first direction for extension of the strap from the housing, the spring tension being released when the spool is rotated in the second direction for retraction of the strap into the housing wherein the spring is configured to retract the strap into the housing;
a lock being coupled to the spool, the lock being releasably engageable with the spool wherein the lock selectively inhibits the spool from being rotated in the first direction for extension of the strap from the housing, the lock including:
a ratchet being positioned within the interior space of the housing, the ratchet being coupled to the spool wherein the ratchet rotates in the first direction when the spool rotates in the first direction and wherein the ratchet rotates in the second direction when the spool rotates in the second direction;
a button being coupled to the handle, the button being actuatable to pivot inwardly toward the interior space of the housing and outwardly from the interior space of the housing;
a pawl being coupled to the button, the pawl being pivotably positioned within the interior space of the housing wherein the pawl is pivotable to contact the ratchet when the button is pivoted inwardly and wherein the pawl is pivotable to release the ratchet when the button is pivoted outwardly, the pawl inhibiting the ratchet from being rotated in the first direction while the pawl is in contact with the ratchet;
a notch extending into the button; and
a lever being pivotably coupled to the handle, the lever being pivotable downwardly to engage the notch wherein the lever inhibits the button from being pivoted inwardly or outwardly relative to the housing while the lever is engaged with the notch, the lever being pivotable upwardly to release the notch.
